(19) United States
(12) Patent Application Publication
(10) Pub. No.: US 2024/0161213 A1
(43) Pub. Date: May 16, 2024

(54) COMPLETE REAL ESTATE MANAGEMENT SYSTEM FOR BUYING, SELLING, MAINTAINING AND IMPROVING REAL ESTATE IN RESIDENTIAL AND COMMERCIAL SECTORS

(71) Applicant: Justin Murcia, Los Angeles, CA (US)

(72) Inventor: Justin Murcia, Los Angeles, CA (US)

(21) Appl. No.: 18/131,463

(22) Filed: Apr. 6, 2023

Related U.S. Application Data
(60) Provisional application No. 63/426,012, filed on Nov. 16, 2022.

(51) Int. Cl. G06Q 50/16

(52) U.S. Cl. CPC G06Q 50/163

(57) ABSTRACT

A complete real estate management system with application platform software will combine major aspects of the real estate process such as banking/loan, property search, property evaluation, construction estimates, personal attachment to the property, and management of the property throughout its life expectancy. The real estate management system) application software will be an entire management system intended to manage the entire real estate industry.

### RELATED APPLICATION

This application relates back U.S. 63/426,012 filed on Nov. 16, 2022 and is incorporated in its entirety.

### BACKGROUND

### Technical Field

This invention relates to a real estate management system for the residential and commercial sectors. In particular, but without limitation, the invention relates to a complete real estate management system with complete information transparency.

The real estate industry is not managed properly. The property buying and selling process is not very efficient. Property owners are uneducated and uninformed. Properties are not maintained, repaired, or managed properly throughout their life expectancy. The process to buy/sell a property takes too long, and the evaluation process of the property is limited. Each buyer needs to complete their own evaluation process of the property. Most potential property sales are canceled due to inefficiencies and inadequacies of the real estate process. The process is mostly one-sided and favors the seller. The real estate individuals/companies typically rush the process to complete the sale. Each participant involved in the process comes from a separate company and these participants are not working in conjunction with each other and the various aspects of the process. In addition, some aspects of the process get overlooked and are not considered in the purchase price of the property. The buyers are typically very uneducated on the property, do not know what repairs are needed and the cost of these repairs. The buyers also do not know the true value of the property and what unknown problems arise in the future, costing the buyer time and money.

The process now is that a real estate agent will assist a buyer with finding a property and nothing more. It is the buyer's responsibility to complete all the other tasks on their own, while accepting the recommendations from the certain individuals that specialize in a particular area, such as banking, property inspection, or construction. But there is not someone to oversee the entire process. Therefore, the buyer will typically disregard most aspects of the process because they do not know what they are doing or what they are supposed to do.

The property evaluation section will be limited and will not include the additional inspections to increase the invasiveness and knowledge of the property. The construction estimate section will be disregarded and a guess estimate will be done to request a credit from the seller, which is typically a lot lower than the real cost of all the necessary repairs. The personal attachment section is typically not completed, given a score, and not transitioned into an actual dollar amount that applies to the purchase price. The follow up section is not done and there is no management/maintenance program in place for the property.

There is no company that currently offers this service. It is the buyer's responsibility to manage their property with no direction or assistance with qualified individuals. All the aspects of the process have never been combined in this fashion. There has never been a software and a company to manage the entire process. The typical property buying process is each buyer must go through the process themselves. This means each buyer will have their own banker, realtor, property inspector, and more. This also means each property will have multiple bankers, realtors, and property inspectors associated with it. This makes it extremely inefficient. One property only needs one banker, one realtor, one property inspector and one construction professional to oversee/manage all aspects of the property.

Therefore, a need exists for a real estate management system to manage all aspects and professionals involved in the real estate process. Such as bankers, loan officers, realtors, property inspectors, appraisers, contractors, and more. These individuals will be working under one company or managed under one company to assure a thorough and complete real estate management process. The real estate management system will integrate all the required aspects of a property, such as management, buying, selling maintaining, repairs, modifications, and more, all in one application. Each property stored within the real estate management system will have an account of all necessary pertinent information required for that property's proper management. Each client that views the account information for that property will have all the necessary information they need to make an accurate decision on that property, for example, whether to buy, sell, seek an appraisal value, determine a purchase price, make necessary repairs, remodel, rezone, or teardown and rebuild.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

A real estate management system for complete inclusion of services, tasks and information transfer between buyers and sellers is disclosed.

The real estate management system includes five major sections of the application, including 1: real estate/banking, 2: property evaluation, 3: construction/estimation, 4: personal aspect and 5: closure/follow up/management. Each major section will have sub-sections where information will need to be inputted or chosen from a preexisting database. The real estate management system software will be used in conjunction with a company—such as the same company as the applicant—familiar with how to use the software. This company will be comprised of professionals such as a loan specialist, real estate agents, property inspectors, construction contractors/estimators, and a software managers/developer. The individuals involved in the process will be educated on how to use the software properly. In some embodiments, contractors are able to advertise on the software.

In another aspect of the disclosure, a method for managing real estate and selling a house with complete inclusion of property sales evaluation, services and information transfer between a seller and a buyer of a property is also disclosed, with an overall real estate management system.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is an example communications network configured to promote and implement aspects of the real estate management system associated with the disclosure.

FIG. 2 illustrates a block diagram of software services included in a real estate management system.

FIG. 3 illustrates a process flow for real estate/banking/loans stage considerations.

FIG. 4a illustrates a process flow for the property evaluation section.

FIG. 4b illustrates another process flow for the property evaluation section.

FIG. 5 illustrates a process flow for the construction/estimation section.

FIG. 6 illustrates a process flow for the personal aspect section.

FIG. 7 illustrates a process flow for the closure/follow-up section.

FIGS. 8a-8c illustrate additional information regarding the real estate management system according to the disclosure.

### DETAILED DESCRIPTION

The elements in the Figures interoperate as explained in more detail below. Before setting forth the detail explanation, however, it is noted that all of the discussion below, regardless of the particular implementation being described, is exemplary in nature, rather than limiting. For example, although selected aspects, features, or components of the implementations are depicted as being stored in memories, all or part of systems and methods consistent with the display systems may be stored on, distributed across, or read from other machine-readable media, for example, secondary storage devices such as hard disks, floppy disks, and CD-ROMs; a signal received from a network; or other forms of ROM or RAM either currently known or later developed.

Furthermore, although specific components of the architecture will be described, methods, systems, and articles of manufacture consistent with the architecture may include additional or different components. For example, a processor may be implemented as a microprocessor, microcontroller, application specific integrated circuit (ASIC), discrete logic, or a combination of other type of circuits or logic. Similarly, memories, may be DRAM, SRAM, Flash, or any other type of memory. Flags, data, databases, tables, and other data structures may be separately stored and managed, may be incorporated into a single memory or database, may be distributed, or may be logically and physically organized in many different ways. Programs may be parts of a single program, separate programs, or distributed across several memories and processors.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The disclosed real estate management system is designed to change the entire real estate industry by improving property ownership from purchase to ownership, and then resale. The software will combine all major aspects of the real estate industry such as banking/loans, property search, property evaluation, construction (repairs, remodels, additions, replacements, installations), construction estimates, personal attachment to the property and management of the property throughout its life expectancy. The software will be an entire real estate management system intended to manage the entire real estate industry. The information collected on a particular property will be more invasive and more diverse covering more areas of the property. The information will be collected before or at the time the property goes on the market. The information will be stored in the database and will be available upon request. The real estate management system software allows for multiple potential buyers to view the property evaluation results, thereby eliminating the need for each buyer to pay for their own property evaluation. This will decrease the total price of the entire process and will increase the potential buyers interested in the property. This real estate management system software will increase the efficiency by assembling all aspects of the process instantaneously. It will also increase the invasiveness, expedite the process, and create a personal connection between the property and the buyer. As the buyer moves through the process, he/she will know more information, determine the true value of the property, and discover if it is the correct decision for them. By making the process more efficient and affordable more potential buyers will be interested in a particular property. The property buyers will be able to evaluate multiple properties for the same price as it costs to evaluate one property.

Goals:

The goal is to offer a software that is cheaper, more invasive but transparent, and with faster results. This will allow the buyer to make a more informed decision in less time it normally takes. Thereby, increasing the potential for success, making the property buying process more efficient and improve the real estate industry.

Scope:

The solution to this problem is to design a software that takes the user/participants through a 5-stage process to input information and/or choose data from a preexisting database. When this data is known, combined, and evaluated as a whole, the user will be able to make an accurate decision. The software will preempt/predict what information is needed and input that information into the software beforehand. Then, the user/participant can just choose to view what information applies to the scenario.

Flow:

The disclosed real estate management system is implemented as a series of stages/sections, to guide the buyer and/or seller through all the critical phase of selling, owning, and buying a property. These stages and sections will be described below in connection with the implementation of the disclosed real estate management system on a communications network allowing users, such as buyers, sellers, realtors, inspectors, contractors, and other users of the disclosed real estate management system.

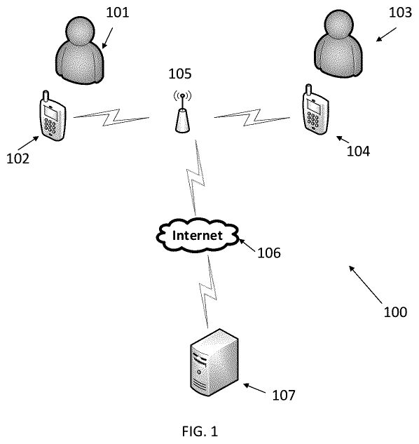

FIG. 1 illustrates an example communications network 100 employed by users (101, 103) that supports the disclosed real estate management system. In an aspect of the disclosure, the users (101, 103) may be buyers, sellers, realtors, inspectors, contractors, and other users of the disclosed real estate management system.

The communications network 100 may include a first user equipment (UE) 102 and a second UE 104. There may be multiple UEs connected to the communications network 100 and the UEs may be smart phones, laptops, tablet devices, smart watches, desktop computers, or other equipment that can connect in a wired or wireless manner. The communications network 100 may include a wired or wireless access point (AP) 105. The AP 105 may be a terrestrial wireless network such as a cellular communications network, WiFi network or other wireless connectivity systems. The AP 105 may be a satellite that supports ground-based communications. Examples of a wired communications network includes Ethernet, fiber, cable or other wired communications connectivity systems.

In an aspect of the disclosure, the AP 105 may connect to the Internet 106, as understood by one of skill in the art. The Internet 106 may include various routers and hubs (not shown).

In an embodiment of the disclosed invention, the Internet 106 may connect UEs (102, 104) to a server 107. The server 107 may contain processors, input units, memory, and output display units (not shown). The server 107 may support the functions of the disclosed invention. The server 107 may be multiple servers and the method of the disclosed invention may be implemented across multiple servers, the UEs (102, 104) or other processing devices as needed. The server 107 may also include a cloud-based collection of one or more servers distributed in different locations and/or or making use of cloud-based applications to implement the disclosed invention.

In an embodiment, the server 107 may be located in local proximity to the UEs (102, 104) such that the UEs (102, 104) do not access the Internet 106 to make use of the disclosed real estate management.

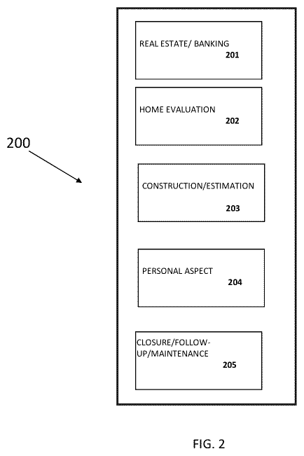

FIG. 2 illustrates a block diagram of software services included in the real estate management system 200. The five major sections of the software are real estate/banking 201, property evaluation 202, construction/estimation 203, personal aspect 204, closure/follow up/management real estate 205. Each major section will have sub-sections where information will need to be inputted or chosen from a preexisting database. The real estate management system software will be used in conjunction with a company —such as the same company as applicant—familiar with how to use the software. This company will be comprised of professionals such as a loan specialist, real estate agents, property inspectors, construction contractors/estimators, and a software managers/developer. The individuals involved in the process will be educated on how to use the software properly.

All necessary data for each section will already be in the software database. The database may be local to a particular server, such as a server that hosts all or part of the real estate management system 200 or may be a distributed database across or more servers, cloud hosting sites or other connected devices to a communications network supporting access to the real estate management system 200. The real estate section 201 will have all the necessary data pertaining the banking, loans, and real estate from a database within the software or from 3^{rd} party companies.

The property evaluation section 202 will provide a property inspection master template with all the necessary data pertaining to all sections of a property and all potential deficiencies found in a property. The unknown information about the property will be inputted into the software at the time of the property inspection.

The construction/estimation section 203 will have all the necessary data related to construction and construction cost estimates as it relates to all sections of a property.

The personal aspect section 204 will have all the necessary questions to ask the buyer along with the scoring system and associated value determination/dollar amount that will be applied to the purchase price of the property.

The closure/follow up/management section 205 will be membership/subscription section that manages the buyers account for future reference and management of the property.

Each section of the real estate management system 200 will be implemented through a process, illustrated in the following aspects. It is to be understood by one of skill in the art that acts indicated in a process flow herein may be performed in the order illustrated in the accompanying figure, simultaneously performed or performed in no particular order.

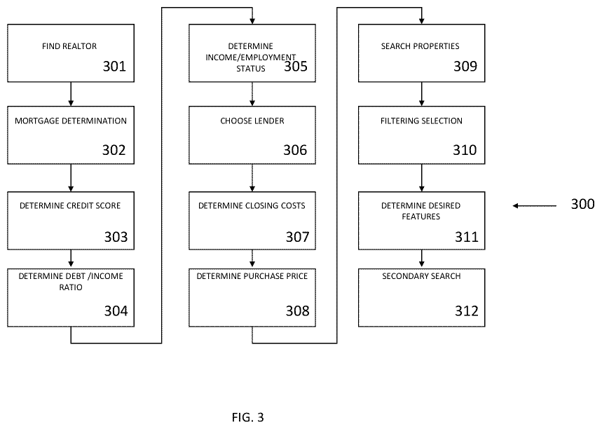

FIG. 3 illustrates a process flow 300 for real estate stage considerations. The real estate stage will take the buyer through determining the correct loan, the appropriate purchase price, and finding the property(s) they want.

In act 301, the real estate management system 200 allows a user to find a real estate agent/qualified individual to assist in the process. The software will provide an option to do a search for realtors educated on the software in your immediate area. A database of individual realtor profiles will be provided either within the software or accumulated from 3^{rd} party real estate offices.

In act 302, real estate management system 200 allows a user to determine what type of mortgage loan is right (FHA, VA, Conventional, USDA, etc.) The software will provide a quick educational tip on each type of loan to assist the buyer in deciding which loan to choose. Input chosen loan type into the software. A database of individual loan officers/bank profiles will be provided either within the software or accumulated from 3rd party companies.

In act 303, the real estate management system 200 allows a user to determine a credit score. The software will provide multiple avenues on how to obtain your credit score. It will also include references to professionals that specialize in managing/repairing a credit score. A credit score is input into the software.

In act 304, the real estate management system 200 allows a user to determine debt-to-income ratio. The software will take the buyer through a series of questions to determine their debt-to-income ratio. The debt-to-income ratio will then be put into the software.

In act 305, the real estate management system 200 allows a user to determine income/employment status. The software will take the buyer through a series of questions to determine their income. Their income will be put into the software.

In act 306, the property seller platform real estate management system 200 allows a user to choose a lender to get pre-approval. The software will provide search results from a database within the software or from 3^{rd} party businesses of various lenders in the area and the potential interest rate that will be offered to the buyer. The lender and rate will be put into the software.

In act 307, the real estate management system 200 allows a user to determine closing costs. The software will educate and list all potential closing costs. The closing costs will then be put into the software.

In act 308, the real estate management system 200 allows a user to determine purchase price. The software will take the results from all previous steps and determine the appropriate purchase price (within a range) for the buyer.

In act 309, the real estate management system 200 software will then do a search for all available property in the area and display all appropriate options from a database within the software or from 3^{rd} party companies.

In act 310, the software will then take the buyer through a series of questions to narrow or filter the selection down. The questions may include, such as, what type of property do you want? (for example, single-family, condo, townhouse, duplex, etc.)

In act 311, the 200 allows a user to describe what features are desired in a property? (for example, size, location, layout, appliances, etc.) Do you want move-in ready or fixer-upper? What location/city do you want to search? What maximum radius do you want to stay in?

In act 312, the real estate management system 200 software will then do a secondary search to find the most appropriate results.

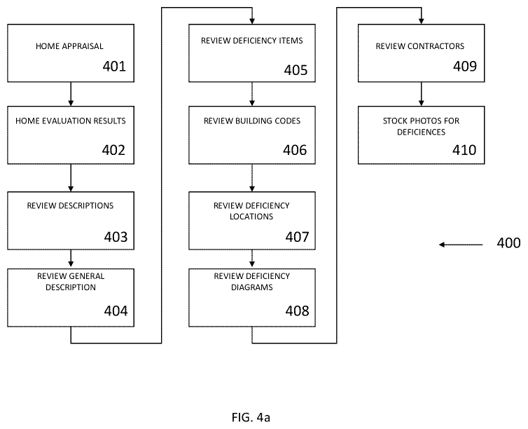

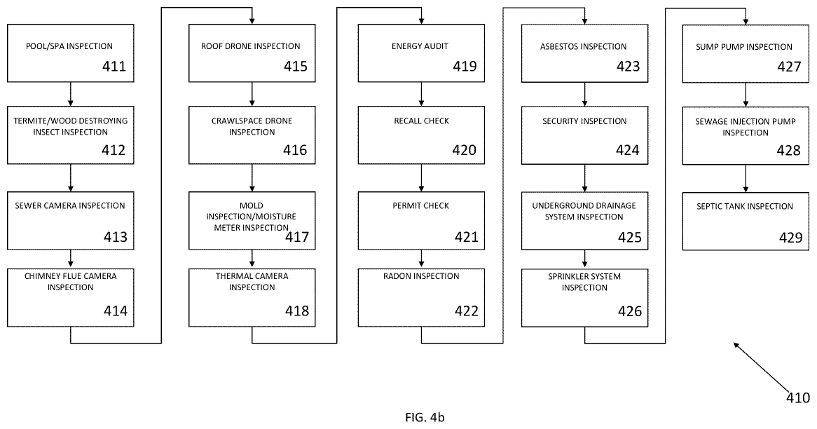

FIG. 4a illustrates a illustrates a process flow 400 for the property evaluation section 202, where the property evaluation stage takes the buyer through all aspects of the property to thoroughly evaluate the property and all its related components on a more invasive level. The property will be pre-evaluated prior to the buyer choosing this property. The property's data/results of all the findings will already be in the software. The buyer will purchase and review all pertinent inspection results.

In act 401, the real estate management system 200 allows a user to review the property appraisal, where the amount will be noted and compared to sell price.

In act 402, the real estate management system 200 allows a user to review property evaluation results, including all description sections and deficiencies. A typical property evaluation will include all areas of the property that are visibly accessible. The report will be divided up by area of the property (exterior, interior, basement, attic, crawlspace, kitchen, bedroom, bathroom, etc.) and/or trade of construction (foundation, plumbing, electrical, roof, HVAC, etc.).

In act 403, the real estate management system 200 allows a user to review descriptions. Each description section will show information pertaining to the property, such as, inspected, not inspected, serviceable, not serviceable, present, and/or not present. It will take note of the style, installation techniques, materials used, life expectancy of materials used, location of equipment, location of access points, location of shut off valves or breakers. It will also note the type of equipment/appliances present in the property with manufacturer name, model number, serial number and age.

In act 404, the real estate management system 200 allows a user to review the general description section, which will show information pertaining to the property, such as 3D scan/virtual walk-through of the property/property, the measurements (digital measurements) layout of the property (blueprint), the square footage of each section (outside/inside, front yard, back yard, and different rooms of the interior space).

In act 405, the real estate management system 200 allows a user to review the deficiency items, which will note a description of the problem and severity of the problem. The deficiency will also include the following items: building codes, deficiency location, diagram/illustration, recommended specific contractor dedicated to that deficiency, stock photo of that deficiency.

In act 406, the real estate management system 200 allows a user to review referenced building codes in a property inspection report.

In act 407, the real estate management system 200 allows a user to review deficiency locations in the property (exterior, interior, front, back, left, right, 1st floor, 2nd floor, bedroom, bathroom, living room, kitchen, garage, etc.) where the individual rooms/areas of the property will be identified by indicators such as bedroom 1, bathroom 2, etc.

In act 408, the real estate management system 200 allows a user to review diagrams/illustrations to show the customer the deficiency.

In act 409, the real estate management system 200 allows a user to review recommended specific contractors to repair the problem and referral to specific contractors in the area (licensed only).

In act 410, the real estate management system 200 allows a user to utilize stock photos to represent deficiencies.

FIG. 4b illustrates a process flow 411 for the property evaluation section 202, where additional property inspection add-ons to the property evaluation stage are provided. These are aspects of the property that can be included if they apply to the property. Each section will have its own description section and deficiencies.

In act 411, a pool/spa inspection may be performed.

In act 412, a termite/wood destroying insect inspection may be performed.

In act 413, a sewer camera inspection (video documenting the condition of the sewer pipe interior) may be performed.

In act 414, a chimney flue camera inspection (video documenting the condition of the flue interior) may be performed.

In act 415, a roof drone inspection (video documenting the condition of the roof surface and related components) may be performed.

In act 416, a crawlspace drone inspection (video documenting the condition of the crawlspace area and related components) may be performed.

In act 417, a mold inspection/moisture meter inspection (documenting areas of potential microbial growth along with air and surface sample test results) may be performed.

In act 418, a thermal camera inspection/moisture meter inspection (documenting areas of concern regarding difference in temperature, plumbing leaks, air leaks, etc.) may be performed.

In act 419, an energy audit (documenting areas of concern regarding energy usage/air leaks/door test results) may be performed.

In act 420, a recall check—to take note of manufacturer/serial number/model number of all appliances and run through database to check for recalls—may be performed.

In act 421, a permit check (recent repairs/remodels, rezoning associated with property address city records/historical records) may be performed.

In act 422, a radon inspection (documenting presence or absence of radon in soil, basement, crawlspace) may be performed.

In act 423, an asbestos inspection (documenting presence or absence of asbestos in siding, flooring, flue pipe, duct work, etc.) may be performed.

In act 424, a security inspection (documenting the condition and proper operation of the alarm system) may be performed.

In act 425, an underground drainage system inspection (documenting the functionality of the underground drainage system) may be performed.

In act 426, a sprinkler system inspection (documenting the proper functionality of the sprinkler system) may be performed.

In act 427, a sump pump inspection (documenting the proper functionality of the sump pump system) may be performed.

In act 428, a sewage injection pump inspection (documenting the proper functionality of the sewage injection pump) may be performed.

In act 429, a septic tank inspection (documenting the proper functionality of the septic tank) may be performed.

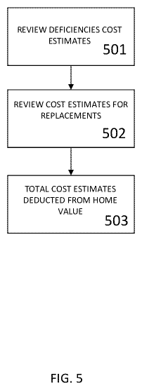

FIG. 5 illustrates a process flow 500 for the construction/estimation section 203. The construction/estimation section takes the buyer through all the repairs that need to be completed and the cost estimates for those repairs.

In act 501, the real estate management system 200 allows an entry or review of cost estimates for each deficiency found/necessary repair noted in the property evaluation report. This can be a partial repair or a full replacement.

In act 502, the real estate management system 200 allows a user to review/provide cost estimates for necessary replacement/end-of-life expectancy items, such as furnace, condenser, water heater, etc.

In act 503, the real estate management system 200 allows a user to determine all cost estimates. The total cost estimate for all repairs will be compared, applied/deducted from/to the sell price and appraisal value.

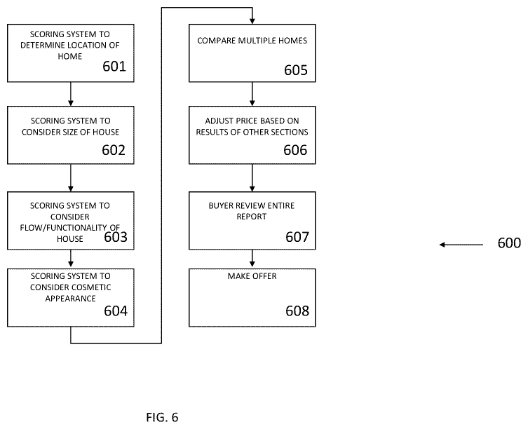

FIG. 6 illustrates a illustrates a process flow 600 for the personal aspect section 204—attachment to the property—where the personal aspect section 204 takes the buyer through a series of questions pertaining to: location, size, functionality, and appearance of the property. The buyer will give a score for each topic. The score will then apply to a dollar amount. That dollar amount will then apply to the purchase price of the property. If it is a low score the buyer should ask for a credit. If it is a high score, the buyer should be willing to pay more for the property.

In act 601, the real estate management system 200 allows a user to determine the location of the property associated with the buyer's other aspects of life, such as work, school, airport, relatives, hobbies, etc. Is it close or far? The buyer will input those other addresses. The distances will be provided. A score will be given by the software.

In act 602, the real estate management system 200 software will ask the buyer questions regarding the size/square footage of the property. (Is it the size you want? does it provide the space you need? etc.) A score will be given by the software.

In act 603, the real estate management system 200 software will ask the buyer questions regarding functionality/operation (does it flow well? etc.) A score will be given by the software.

In act 604, the real estate management system 200 software will ask the buyer questions regarding cosmetic/appearance (do you like the appearance/colors/materials? etc.) A score will be given by the software.

In act 605, the real estate management system 200 allows users to have the option to compare multiple properties.

In act 606, after each section is completed, the real estate management system 200 software will adjust the price the buyer should pay based on the results of each section. For example, if the property needs a lot of repairs, the recommended purchase price will go down. But if the buyer has a strong personal attachment to the property, the price will go up. The software will also have the ability to give multiple recommended purchase prices based on how much of a credit the software recommends requesting from the seller.

In act 607, after the buyer has reviewed the entire report, they will know which property is perfect for them, how much the repairs will cost, and how much they should pay for the property. This is based on choosing a property, evaluating the property, determining the cost of repairs, and applying a personal attachment.

In act 608, the real estate management system 200 allows a buyer to make an offer.

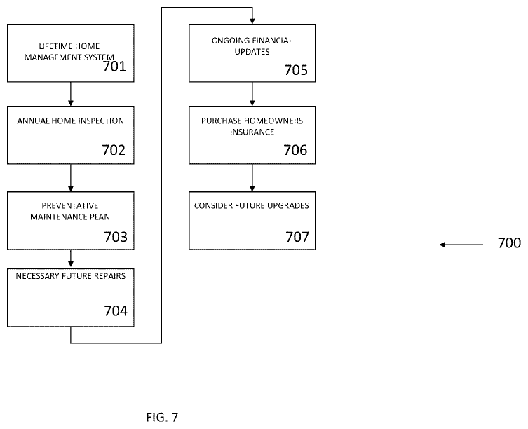

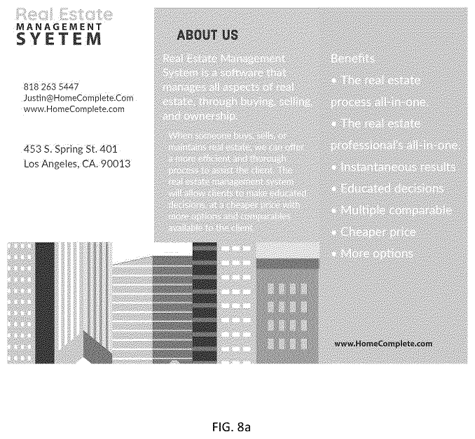

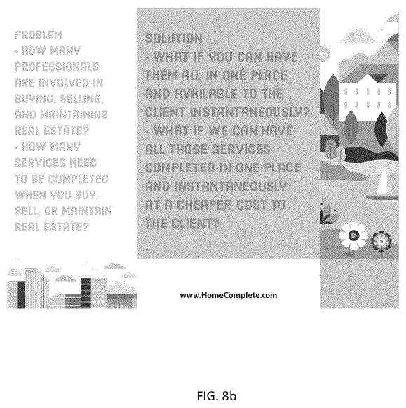

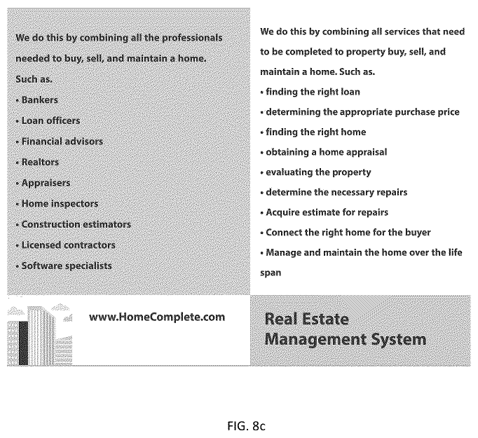

FIG. 7 illustrates a illustrates a process flow 700 for the closure/follow-up/management of the property section 205, where this section will be a membership/subscription section that stores the records of the property for future reference and management of the property. In an aspect of the disclosure, the real estate management system 200 will include a management program to manage and oversee the property for the life of the property, to manage all aspects such as: annual property inspections, preventive maintenance, all necessary repairs/remodels/additions/tear-downs and rebuilds. The management program includes financial updates that apply to the property, annual property inspections, repairs, remodels, additions, preventive maintenance plans, rezoning and tear-down/rebuilds. All management to the property will be completed by qualified individuals from a database within the software or from 3^{rd} party companies. These individuals will be approved by the real estate management system 200 as qualified persons to work on the property.

In act 701, after the buyer purchases the property, it will be entered into a lifetime management system. The buyer can choose to become a member or not.

In act 702, an annual property inspection will be completed to maintain a “certified property” status (property warranty/recertify property).

In act 703, a preventive maintenance plan will be implemented, and maintenance will be completed by qualified contractor only (certified, by the licensed contractor only).

In act 704, necessary future repairs will be completed by qualified contractors only and repairs will be certified (certified, by the licensed contractor only from a database within the software or from 3^{rd} party companies).

In act 705, ongoing financial updates regarding refinance, housing market, interest rates, building materials, manufacturers will be sent to the member to educate them on their property and everything associated with it.

In act 706, the real estate management system 200 allows a user to purchase property owners' insurance, and providers will be available within the software or from 3^{rd} party companies.

In act 707, the real estate management system 200 allows a user to consider whether additional aspects or upgrades available are recommendations appropriate for the property such as future remodels, additions, or change in zoning (from single family to multifamily).

Sequences and processes for providing real estate management system services and tasks described herein may be encoded in a signal bearing medium, a computer readable medium such as a memory, programmed within a device such as one or more integrated circuits, or processed by a controller or a computer. If the methods are performed by software, the software may reside in a memory resident to or interfaced to the any type of non-volatile or volatile memory interfaced or resident to the memory incorporated in the components in the communications network (100). Such memory may include an ordered listing of executable instructions for implementing logical functions. A logical function may be implemented through digital circuitry, through source code, through analog circuitry, or through an analog source such through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A real estate management system, including residential and commercial properties, for complete inclusion of services, tasks and information transfer between buyers and sellers comprising: a real estate management software service, a property buying service, a property evaluation software service, a construction/estimation software service, a personal aspect software service and a closure/follow-up software service.
